(19) United States
(12) Patent Application Publication
(10) Pub. No.: US 2025/0097730 A1
(43) Pub. Date: Mar. 20, 2025

(54) DETECTION OF POORLY DEPLOYED FWA TERMINALS

(71) Applicant: Telefonaktiebolaget LM Ericsson (publ), Stockholm (SE)

(72) Inventors: Anders FURUSKÄR, Stockholm (SE); Niklas JALDÉN, Enköping (SE); Birgitta OLIN, Bromma (SE); Jialu LUN, Solna (SE)

(73) Assignee: Telefonaktiebolaget LM Ericsson (publ), Stockholm (SE)

(21) Appl. No.: 18/695,573

(22) PCT Filed: Sep. 28, 2021
(86) PCT No.: PCT/SE2021/050947

§ 371 Date: Mar. 26, 2024

(51) Int. Cl. H04W 24/02; H04W 16/10; H04W 16/18; H04W 64/00

(52) U.S. Cl. CPC H04W 24/02; H04W 16/10; H04W 16/18; H04W 64/003

(57) ABSTRACT

The present disclosure relates to a method of remotely controlling deployment of a fixed wireless access (FWA) device and a device performing the method. In a first aspect, a method of remotely controlling deployment of an FWA device (11) is provided comprising determining (S101) quality of a first radio channel established with the FWA device (11) to be deployed, determining (S102) quality of at least a second radio channel established with a wireless communication device (18) being located in a vicinity of the FWA device (11) to be deployed, determining (S103) a difference in quality between the first and the at least one second radio channel and if the quality of the second channel exceeds the quality of the first channel by a quality threshold value; indicating (S104) a redeployment action to be performed for the FWA device (11) to increase the quality of the first radio channel.

### TECHNICAL FIELD

The present disclosure relates to a method of remotely controlling deployment of a fixed wireless access (FWA) device and a device performing the method.

### BACKGROUND

Fixed wireless access (FWA) technology is commonly used to offer wireless, or radio-based, connectivity to users in fixed positions. Radio connectivity may be supplied by a radio base station (RBS) to a customer premises equipment (CPE) in a fixed location, such as a wall- or roof-mounted stationary wireless access point, which in turn supplies radio connection to local moving users within coverage of the CPE. From the mobile network point of view, the end user is however stationary.

Another typical FWA setup is a wireless router communicating with a radio base station, which router in its turn locally provides a group of devices such as mobile phones, computers, televisions sets, gaming consoles, etc. with a wireless connection to the RBS. Such router is semi-stationary in that it can be moved around the premises, but is usually placed in a fixed initial position and is thereafter not moved.

An FWA device (be it stationary or semi-stationary) is often used as an alternative to fibre installation in areas where fibre is not available or too costly.

Since the FWA device and RBS are stationary, or at least semi-stationary, dominating paths of the radio channel are fairly constant. This allows the use of fixed directional antennas, also at the user side. If correctly directed, these antennas amplify the desired signal and attenuate interference, which in turn leads to improved performance, e.g. higher data rates, better coverage and greater capacity for the connected devices.

The quality of the radio link is greatly dependent on the positioning of the FWA device relative to the RBS. For instance, the antenna(s) of the FWA device at the user side need to be adequately arranged from a radio perspective and directed such that they capture the main paths of the radio channel, e.g. directed towards the base station in the case of a line-of-sight channel. Positioning and directing the antenna may be done by a professional, which implies a cost for the operator or end-user.

Alternatively, it can also be done by the end-user, in which case the risk of a poorly placed FWA device and/or erroneously directed antenna is larger. After installation, the FWA device and/or antenna can also accidentally be moved or redirected. Hence, there are multiple scenarios where the FWA device is poorly deployed.

A poorly deployed FWA device in terms of placement and/or antenna direction will result in a lower throughput (i.e. decreased link capacity) than potentially could be achieved. However, the poor FWA device deployment is not only a problem for the end user since satisfying traffic demand of such as user also is more costly for a network operator in terms of assigning network resources in the form of for instance power or bandwidth.

### SUMMARY

An objective is to solve, or at least mitigate, this problem in the art and provide a method of remotely controlling deployment of an FWA device.

This object is attained in a first aspect by a method of remotely controlling deployment of an FWA device comprising determining quality of a first radio channel established with the FWA device to be deployed, determining quality of at least a second radio channel established with a wireless communication device being located in a vicinity of the FWA device to be deployed, determining a difference in quality between the first and the at least one second radio channel and if the quality of the second channel exceeds the quality of the first channel by a quality threshold value; indicating a redeployment action to be performed for the FWA device to increase the quality of the first radio channel.

This object is attained in a second aspect by a radio base station configured to remotely control deployment of an FWA device, said radio base station comprising a processing unit and a memory, said memory containing instructions executable by said processing unit, whereby the radio base station is operative to determine quality of a first radio channel established with the FWA device to be deployed, determine quality of at least a second radio channel established with a wireless communication device being located in a vicinity of the FWA device to be deployed, determine a difference in quality between the first and the at least one second radio channel and if the quality of the second channel exceeds the quality of the first channel by a quality threshold value; indicate a redeployment action to be performed for the FWA device to increase the quality of the first radio channel.

Advantageously, with this method of controlling deployment of an FWA device, a poorly deployed FWA device is detected by determining the quality of a channel established with the FWA device and the quality of a channel established with a neighbouring device, such as a neighbouring FWA device, and indicate a redeployment action to a user of the poorly deployed FWA device, or alternatively to a network operator or 3^{rd} party which may send out maintenance personnel to redeploy the device. The user/maintenance personnel may thus swiftly redeploy the FWA device 11 accordingly—for instance by moving the FWA device to a new physical location—and thus greatly improve the resulting quality of the radio channel established between a radio base station and the FWA device.

In an embodiment, the indicating of the redeployment action comprises sending control information to the FWA device being configured to control a visual indicator of the FWA device guiding the user on how to perform the redeployment action.

In an embodiment, the indicating of the redeployment action comprises sending control information to the FWA device being configured to control an audio indicator of the FWA device guiding the user on how to perform the redeployment action.

In an embodiment, the indicating of the redeployment action comprises sending control information to an app executing on a device of the user guiding the user on how to perform the redeployment action.

In an embodiment, the redeployment action comprises one or more of moving the FWA device to a different location and redirecting one or more antennas with which the FWA device is equipped.

In an embodiment, the redeployment action comprises assigning a quality measure to each of a number of different locations to which the FWA device can be moved and/or to each of a number of different antenna directions.

In an embodiment, the determining of the quality of the first radio channel further comprises determining a location of the FWA device to be deployed; and the determining of the quality of the at least one second radio channel further comprises determining a location of the wireless communication device.

In an embodiment, the wireless communication device is considered to be located in a vicinity of the FWA device to be deployed if the distance between the two devices does not exceed a set maximum distance.

In an embodiment, the method further comprises detecting type of FWA device to be deployed, the detected FWA device type being taking into account when determining the redeployment action to be performed.

In an embodiment, wherein the detecting of the type of FWA device to be deployed comprises detecting whether the FWA device is stationary or semi-stationary.

In a third aspect, a computer program is provided comprising computer-executable instructions for causing a device to perform steps recited in the method of the first aspect when the computer-executable instructions are executed on a processing unit included in the device.

In a fourth aspect, a computer program product is provided comprising a computer readable medium, the computer readable medium having the computer program according to the third aspect embodied thereon.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a prior art wireless communication system utilizing FWA;

FIG. 2 illustrates a wireless communication system utilizing FWA, in which remote deployment control according to an embodiment is implemented;

FIG. 3 shows a flowchart illustrating a method of remotely controlling deployment of an FWA device according to an embodiment;

FIG. 4 shows a flowchart illustrating a method of remotely controlling deployment of an FWA device according to a further embodiment;

FIG. 5 illustrates a wireless communication system utilizing FWA, in which remote deployment control according to another embodiment is implemented; and

FIG. 6 illustrates a device configured to remotely control deployment of an FWA device according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

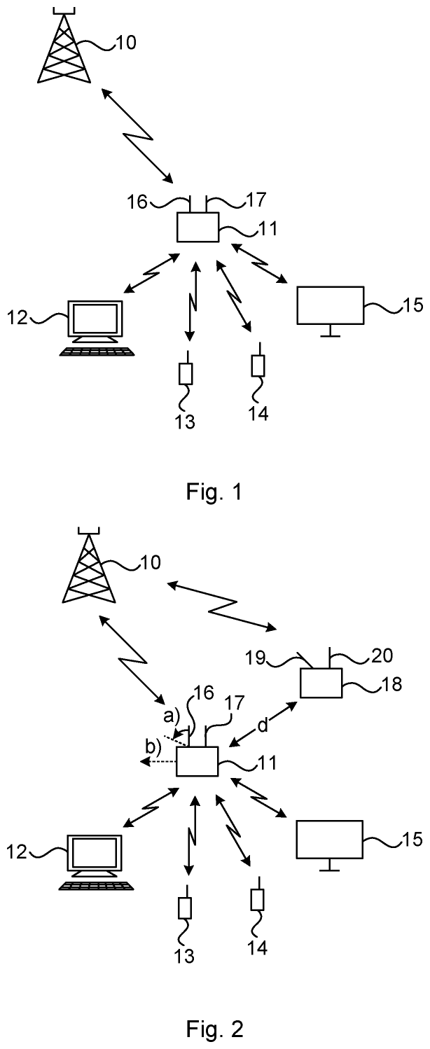

FIG. 1 illustrates an FWA setup where a radio base station (RBS) 10 communicates over a radio channel with an FWA device in the form of a wireless access point (WAP) 11 which in its turn provides a radio connection in the form of a local WiFi to a computer 12, a first mobile phone 13, a second mobile phone 14 and a television set 15 located within a coverage area of the WiFi provided by the WAP 11. These devices are commonly referred to as User Equipment (UE).

In this example, the wireless access point 11 is equipped with a first antenna 16 and a second antenna 17 thereby providing for a so-called Multiple Input Multiple Output (MIMO) configuration in order to improve the quality of the radio channel established with the RBS 10.

As discussed, the deployment of the WAP 11—i.e. its physical placement and/or antenna configuration—is important for attaining a high quality of the radio channel established with the RBS 10 and consequently for being able to provide a high-quality radio connection between the RBS 10 and the devices 12-15 connecting to the local WiFi.

For example, it is typically beneficial to provide a free line-of-sight between the RBS 10 and the WAP 11 and there is typically one or a couple of different antenna configurations which are more beneficial than others for attaining a high-quality radio channel with the RBS 10 and thus to be able to provide a high-quality WiFi to the UEs 12-15.

However, such assessment is difficult to make for an end-user setting up the WAP 11.

FIG. 2 illustrates a scenario where a network device in an embodiment—in this example the RBS 10—remotely controls deployment of the WAP 11. As is understood, other envisaged network devices may instruct the RBS 10 how to control deployment of the WAP 11, for instance core network devices 102, such as a Mobility Management Entity (MME) in case of a Long Term Evolution (LTE) network, or an Access and Mobility Management Function (AMF) in case of a fifth generation (5G) communication network. Further, this may be performed by a device specially dedicated for the purpose such as an Internet server, or even by a cloud implementation involving a plurality of distributed devices.

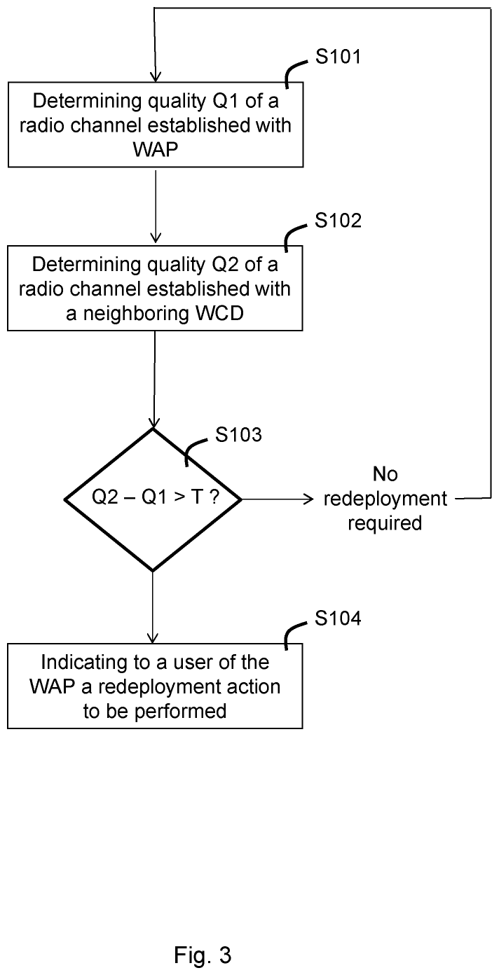

FIG. 3 shows a flowchart illustrating a method of controlling deployment of the WAP 11 according to an embodiment.

With reference to FIGS. 2 and 3, in step S101 the RBS 10 determines quality Q1 of a first radio channel established with the WAP 11 and in step S102, the RBS 10 determines quality Q2 of a second radio channel established with a neighbouring wireless communication device (WCD) 18 located in a vicinity of the WAP 11, such as within a distance d from the WAP 11.

A number of different quality metrics may be envisaged, such as level of received power, peak data throughput, direction of arrival for a received signal, angle spread, delay spread, etc. Further, any combination of these or other metrics may be envisaged, as well as weighted versions of the metrics.

Further, location of the WAP 11 and the neighbouring WCD 18 may be determined using any existing positioning method such as triangularization, fingerprinting, direction of arrival of signals, time of arrival of signals, geographical addresses of the premises in which the WAP 11 and WCD 18 is deployed, etc. The location of the WAP 11 may be determined during step S101 while the location of the WCD 18 may be determined in step S102. For these determined locations, it may be ensured in step S102 that the neighbouring WCD 18 indeed is within the vicinity of the WAP 11—i.e. being within a maximum allowed distance d from the WAP 11.

As is understood, the neighbouring WCD 18 may be a semi-stationary router such as the WAP 11, a stationary CPE router, or even a mobile phone. In other words, the neighbouring WCD 18 is not necessarily an FWA device. In this particular example, the WCD 18 is a router equipped with two antennas 19, 20 similar to the WAP 11. In practice, the WCD 18 may be a wireless access point located at a neighbouring household as compared to the WAP 11.

If in step S103 the RBS 10 determines that the quality Q2 of the channel established with the neighbouring wireless communication device 18 is noticeably better than the quality Q1 of the channel established with the WAP 11—for instance Q2−Q1>T—where Tis an appropriately selected quality threshold value, it can be concluded that a redeployment of the WAP 11 likely could result in improved quality Q1 of the first channel. It is noted that other quality relationships may be considered, such as e.g. Q2/Q1, where the relation between the two metrics should exceed a threshold value.

Thus, the higher quality Q2 of the neighbouring WCD 18 may be viewed upon as the “expected” quality that the quality Q1 of the first channel may reach upon successful redeployment of the WAP 11.

If on the other hand there is a small or no difference in quality between the first and the second channel, it may be concluded that the WAP 11 already is correctly deployed, and no further action is taken.

As can be seen in FIG. 3, steps S101-S103 may repeatedly be performed to detect any arising need for redeployment. For instance, it may be that the WAP 11 has been (intentionally or unintentionally) repositioned from when location to another, in which case a redeployment may be desired to take such repositioning into account. Further, a new structure such as a building may have been erected between the WAP 11 and the RBS 10 thereby changing propagation path of signals transferred to/from the RBS 10.

In step S104, the RBS 10 indicates to a user a redeployment action to be performed for the WAP 11. This may be performed utilizing a WAP display to visually indicate to the user how the redeployment is to be performed based on redeployment control signals transferred from the RBS 10, or a simpler light-emitting diode (LED) arrangement indicating wither a new deployment is better than a previous deployment.

Alternatively, the WAP 11 may be arranged with audio capability where for instance a beeping sound is output, the maximal volume of which is reached when the user moves the WAP 11 and/or redirects its antennas 16, 17 such that an “optimal” radio channel is achieved.

In another alternative, the user runs a configuration app on her smart phone 13 when setting up the WAP 11, whereby the RBS 10 sends instructions to the configuration app on how to best redeploy the WAP 11 in order to improve the quality Q1 of the radio channel established between the RBS 10 and the WAP 11.

Further, in case a user does not have access to a smart phone, it is envisaged that a text message is sent with the instructions, e.g. to a regular mobile phone of the user or to a fixed telephone.

As an example, illustrated in FIG. 2, the redeployment action to be performed by the user may be to a) redirect the first antenna (“redirect first antenna 50° to the northwest”) and/or to b) move the WAP 11 a given distance (“move router 20 cm to the left”).

As an alternative, the redeployment action is indicated to the operator of the network serving the FWA device 11, or a 3^{rd} party service provider. In a scenario where for some reason the user cannot attain a higher quality by performing the redeployment, or if the user has indicated that he/she does not desire to receive a redeployment indication, it may be envisaged that maintenance personnel of the network operator or the 3^{rd} part service provider makes a home visit to carry out the indicated redeployment action. Further, the maintenance personnel may be presented to the proposed redeployment action at the premises of the user as described hereinabove, for instance by means of a visual or audial redeployment action indication presented by the WAP 11.

The RBS 10 may indicate in more or less detail to the user/network operator/3^{rd} party which redeployment action to be performed. For instance:
The user is instructed to perform redeployment and enters a “probing”-phase. The user moves the WAP 11 and is aided by the RBS 10 as to whether the new location is better or worse than the previous (cf. the above-described beeping alert and/or LED alert and/or text message).
The user is instructed to redirect one or both the antennas 17, 18 to a preferred angle as indicated on the WAP display or in the configuration app. The redirection angle may be determined by RBS 10 by computing propagation prediction models capable of describing angular characteristics such as geometrical ray-tracing or similar.
The user is asked to redeploy the WAP 11 by placing it in a window or changing deployment position to another window. It may even be envisaged that the user is given detailed instructions from the RBS 10 which window is preferred (or even which particular position is preferred) since the RBS 10 typically is aware of the geographical coordinates of the WAP 11 and the orientation of the building is publicly available and can through geometric computations be determined by the RBS 10.
The user may be informed that a neighbour has a better working deployment and thus can assist in redeploying the WAP 11 (or at least how it should be deployed).
The user may be informed of a plurality of different locations and/or antenna directions to which the WAP 11 may be redeployed for improving the channel quality. It is further envisaged in an embodiment, that a quality measure is associated with each different location/antenna direction such that the user may select e.g. in which one of a number of different locations the WAP 11 should be placed. This is particularly advantageous in a scenario where for some reason one location is not suitable to the user, which subsequently may select for instance a second-best location.

Advantageously, with this method of controlling deployment of an FWA device, in this case embodied by the WAP 11, a poorly deployed FWA device is detected and a redeployment action is indicated to the user who swiftly can redeploy the FWA device 11 accordingly and thus greatly improve the resulting quality of the radio channel established between the RBS 10 and the FWA device 11.

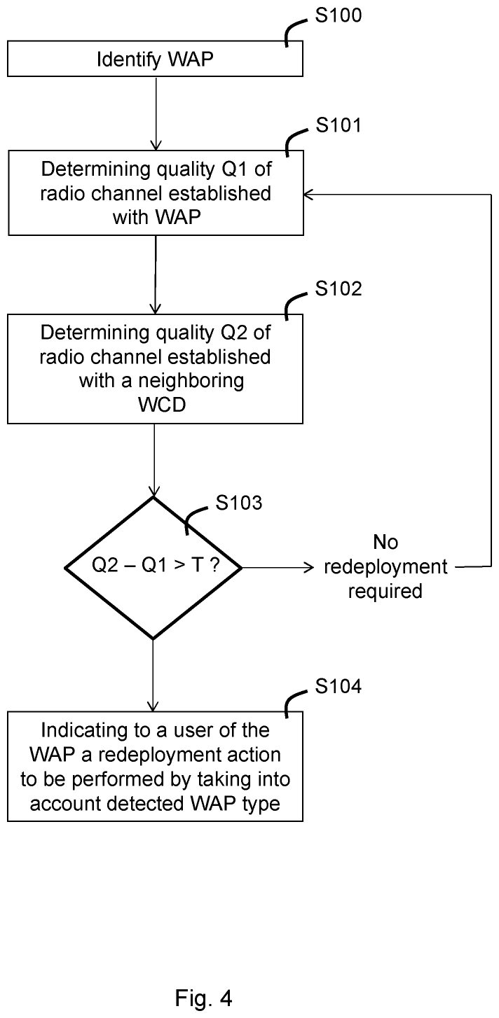

FIG. 4 illustrates a further embodiment, where in a first step S100, the RBS 10 detects which type of device the FWA device 11 to be deployed is, i.e. whether or not it actually is a stationary or semi-stationary device. For instance, the FWA device 11 may be a stationary CPE such as a wall- or roof-mounted access point, or a semi-stationary device such as the above-described WAP 11, but it may also by a non-stationary device such as a mobile phone in which case deployment control is not meaningful.

Further, it is advantageous for the RBS 10 to be able to detect if the FWA device 11 is a stationary device, i.e. a device which cannot be physically relocated but where antenna redirection is possible (such as a fixedly mounted access point), or a semi-stationary device which indeed can be moved and which antenna(s) may redirected (such as a portable router), since that likely would affect the proposed redeployment action.

Hence, the RBS 10 detects in step S100 which type of device the FWA device 11 is and takes the detected type into account upon indicating a redeployment action in step S104, for instance whether or not the device can be relocated or if only antenna redirection is possible. This may be done in different ways according to embodiments described below.

For instance, an FWA device may (a) hold a subscription indicating FWA status, (b) allow higher transmit power or be equipped with directive antenna(s) as compared to a non-stationary device such as a mobile phone or a tablet thereby indirectly identifying the device as an FWA device, or (c) be identified from an International Mobile Equipment Identity (IMEI) associated with the FWA device, indicating for instance that the device 11 is a router.

It may further be envisaged that the user runs a configuration app as previously discussed, where the user indicates that the device 11 indeed is an FWA device.

For a device which is not detected as an FWA device using any one of the above-discussed options, it may still be detected as a stationary or semi-stationary FWA device by the RBS 10 collecting channel reports or uplink (UL) signalling statistics from the device 11 to be deployed as listed in the following.
A plurality of channel reports are collected comprising one or more of well-known parameters such as precoder matrix indicator (PMI), rank indicator (RI) and channel quality indicator (CQI). If the parameters of the reports are predominately similar when collected over a longer time period, the device 11 is classified as an FWA device (i.e. either stationary or semi-stationary).
A plurality of UL channel characteristics are collected. Examples of channel characteristics are level of received power, angle spread or delay spread of signals being sent in the UL. A stationary device typically exhibits constant or very slow varying changes to angle and or delay spread and average received power (averaged over a period of a few seconds).
A series of complex channel estimates are performed. From time series of the channel estimates, a doppler spectrum can be estimated through fast Fourier transform (FFT). The estimated doppler spectrum will indicate if the device 11 is stationary.

Thus, after the device 11 has been identified as an FWA device, in this case a WAP, the method of FIG. 4 proceeds to performing steps S101-S104 as previously discussed in detail with reference to FIG. 3 with the addition in step S104 that the detected device type is taken into account when determining the redeployment action to be performed.

As is understood, once the FWA device 11 has been identified in step S100, it typically does not have to be re-identified again (at least not for some time); it may be envisaged that a subscription of the FWA device 11 is moved to a mobile or that the FWA device 11 is moved within a building. This is also true of the device should be identified as a mobile device in step S100.

In an embodiment, with reference to step S102 of FIG. 3, it is envisaged that quality of a number of radio channels established between the RBS 10 and a corresponding number of neighbouring wireless communication devices is determined.

For instance, assuming that a position of the WAP 11 is identified (possibly as a geographical address provided by the user) and quality of the radio channel of four other FWA devices being located on the same street as the WAP 11 is determined.

In an example, the four FWA devices report Reference Signal Received Power (RSRP) to be −90 dBm while the WAP 11 reports RSRP to be −110 dBm. The RBS 10 will-based on this reporting-conclude that the WAP 11 needs to be redeployed to possibly reach an expected RSRP of −90 dBm, and an instruction is provided to its user as previously has been described.

As is understood, channel properties are not necessarily measured in real-time by the RBS 10 in order to determine channel quality but could be collected by the RBS 10 but could be collected from a network database containing quality metrics of a great number of FWA devices and their geographical positions. Further, a determined channel quality may be based on stored historical data.

The neighbouring wireless communication device 18 being located in a vicinity of the WAP 11 is not necessarily an FWA device, but may alternatively be a regular UE such as a mobile phone or a tablet. If so, if the determined channel quality Q2 of a regular UE being located outdoors is superior to the channel quality Q1 of the (indoors) WAP 11, it may be concluded that WAP redeployment is required.

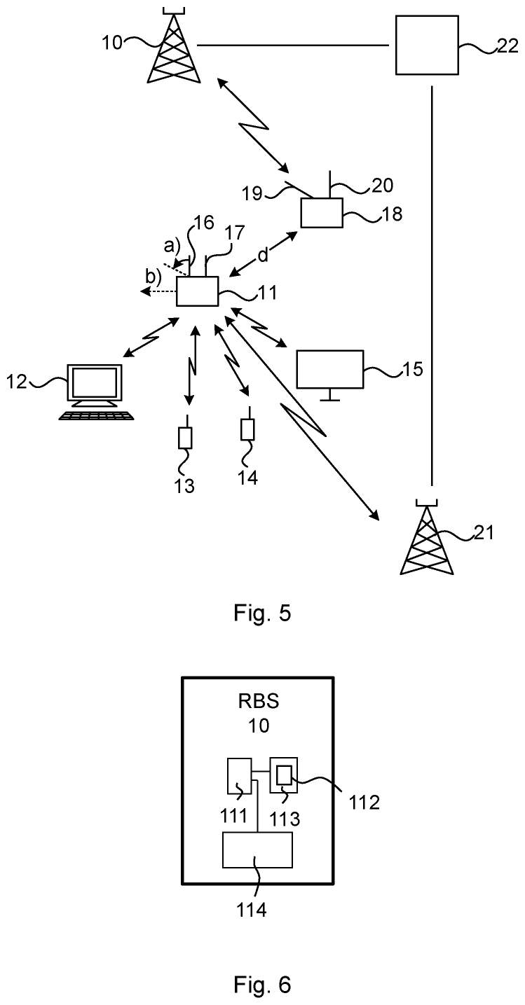

FIG. 5 illustrates a scenario slightly different from that of FIG. 2. In this scenario, the WAP 11 is located at an edge of a cell served by first RBS 10, whereupon the WAP 11 connects to neighbouring second RBS 21. For instance, it may happen that the WAP 11 is placed such that an obstacle (e.g. a wall) located in the path between the WAP 11 and the first RBS 10 attenuates the signals being sent between the WAP 11 and the first RBS 10, As a result, the WAP 11 will switch over to the second RBS 21 offering a better channel.

Thus, in this scenario-again with reference to the flowchart of FIG. 3—in step S101 the second RBS 21 (rather than the first RBS 10) determines quality Q1 of a first radio channel established with the WAP 11 while in step S102, the first RBS 10 determines quality Q2 of a second radio channel established with the neighbouring WCD 18 located in a vicinity of the WAP 11 (such as within a distance d from the WAP 11).

In step S103, in order to determine a difference in quality between the first and the second radio channel, the first RBS 10 may communicate an indication of the quality measure Q2 to the second RBS 21 over an interface referred to as X2 between the two RBSs wherein the second RBS 21 performs steps S103 and S104, or alternatively the quality measure Q1 may be communicated by the second RBS 21 to a central device 22 (being for instance an MME), while the quality measure Q2 is communicated to the MME 22 by the first RBS 10. In this exemplifying embodiment, it is assumed that Q1 and Q2 are communicated to the MME 22. Thus, the MME 22 indirectly determines Q1 (cf. S101) and Q2 (cf. S102) by acquiring the respective quality metric from the first RBS 10 and the second RBS 21.

If in step S103 the MME 22 determines that the quality Q2 of the channel established with the neighbouring WCD 18 is noticeably better than the quality Q1 of the channel established with the WAP 11—for instance Q2−Q1>T—where Tis an appropriately selected quality threshold value, it can be concluded that a redeployment of the WAP 11 likely could result in improved quality Q1 of the first channel.

The MME 22 will thus indicate to a network operator or 3^{rd} party, or to the user of the WAP 11 via the second RBS 21, a redeployment action to be performed.

For instance, in this particular scenario, it may be that it is more preferred that the WAP 11 is positioned such that it connects to the first RBS 10 rather than to the second RBS 21. Accordingly, the MME 22 may via the second RBS 21 indicate in step S104 to the user of the WAP 11 that the WAP 11 is to be redeployed to a position where the above-mentioned example wall no longer forms an obstacle in the path between the WAP 11 and the first RBS 10. With this redeployment, the WAP 11 will connect to the first RBS 10 rather than to the second RBS 21.

FIG. 6 illustrates a device 10, such as an RBS, configured to remotely control deployment of an FWA device according to an embodiment, where the steps of the method performed by the device 10 in practice are performed by a processing unit 111 embodied in the form of one or more microprocessors arranged to execute a computer program 112 downloaded to a storage medium 113 associated with the microprocessor, such as a Random Access Memory (RAM), a Flash memory or a hard disk drive. The processing unit 111 is arranged to cause the device 10 to carry out the method according to embodiments when the appropriate computer program 112 comprising computer-executable instructions is downloaded to the storage medium 113 and executed by the processing unit 111. The storage medium 113 may also be a computer program product comprising the computer program 112. Alternatively, the computer program 112 may be transferred to the storage medium 113 by means of a suitable computer program product, such as a Digital Versatile Disc (DVD) or a memory stick. As a further alternative, the computer program 112 may be downloaded to the storage medium 113 over a network. The processing unit 111 may alternatively be embodied in the form of a digital signal processor (DSP), an application specific integrated circuit (ASIC), a field-programmable gate array (FPGA), a complex programmable logic device (CPLD), etc. The device 10 further comprises a communication interface 114 (wired and/or wireless) over which the device 10 is configured to transmit and receive data.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of remotely controlling deployment of a fixed wireless access (FWA) device, the method comprising:
determining a quality of a first radio channel established with the FWA device;
determining a quality of a second radio channel established with a wireless communication device being located in a vicinity of the FWA device;
determining-(S a difference in quality between the first and the second radio channel; and
after determining that the quality of the second channel exceeds the quality of the first channel by a quality threshold value, indicating a redeployment action to be performed for the FWA device to increase the quality of the first radio channel.

2. (canceled)

3. The method of claim 1, the indicating of the redeployment action comprising:
sending control information to the FWA device being configured to control a visual indicator of the FWA device guiding a user of the FWA device on how to perform the redeployment action.

4. The method of claim 1, the indicating of the redeployment action comprising:
sending control information to the FWA device being configured to control an audio indicator of the FWA device guiding a user of the FWA device on how to perform the redeployment action.

5. The method of claim 1, the indicating of the redeployment action comprising:
sending control information to an app executing on a device of a user guiding the user on how to perform the redeployment action.

6. The method of claim 1, wherein
the redeployment action comprises moving the FWA device to a different location and/or redirecting one or more antennas with which the FWA device is equipped.

7. The method of claim 6, the redeployment action comprising assigning a quality measure to each of a number of different locations to which the FWA device can be moved and/or to each of a number of different antenna directions.

8. The method of claim 1, wherein
the determining of the quality of the first radio channel further comprises: determining a location of the FWA device to be deployed
the determining of the quality of the at least one second radio channel further comprises: determining a location of the wireless communication device, and
the wireless communication device is considered to be located in a vicinity of the FWA device to be deployed if the distance between the two devices does not exceed a set maximum distance (d).

9. (canceled)

10. The method of claim 1, further comprising:
detecting type of FWA device to be deployed, the detected FWA device type being taking into account when determining the redeployment action to be performed, wherein
the detecting of the type of FWA device to be deployed comprises detecting whether the FWA device is stationary or semi-stationary.

11. (canceled)

12. A non-transitory computer readable storage medium storing a computer program comprising computer-executable instructions for causing a device to perform the method of claim 1.

13. (canceled)

14. A device configured to remotely control deployment of a fixed wireless access, (FWA) device, comprising:
a processing unit; and
a memory, said memory containing instructions executable by said processing unit, wherein the radio base station is operative to:
determine quality of a first radio channel established with the FWA device to be deployed;
determine quality of at least a second radio channel established with a wireless communication device being located in a vicinity of the FWA device to be deployed;
determine a difference in quality between the first and the at least one second radio channel; and
if the quality of the second channel exceeds the quality of the first channel by a quality threshold value, indicate a redeployment action to be performed for the FWA device to increase the quality of the first radio channel.

15. The device of claim 14, further being operative to indicate the redeployment action to be performed to a user of the FWA device, an operator of a network serving the FWA device or a 3rd party.

16. The device of claim 15, further being operative to, when indicating the redeployment action:
send control information to the FWA device being configured to control a visual indicator of the FWA device guiding the user on how to perform the redeployment action.

17. The device of claim 15, further being operative to, when indicating the redeployment action:
send control information to the FWA device being configured to control an audio indicator of the FWA device guiding the user on how to perform the redeployment action.

18. The device of claim 15, further being operative to, when indicating the redeployment action:
send control information to an app executing on a device of the user guiding the user on how to perform the redeployment action.

19. The device of claim 15, the redeployment action being configured to comprise one or more of moving the FWA device to a different location and redirecting one or more antennas with which the FWA device is equipped.

20. The device of claim 19, the redeployment action being configured to assign a quality measure to each of a number of different locations to which the FWA device can be moved and/or to each of a number of different antenna directions.

21. The device of claim 15, further being operative to, when determining the quality of the first radio channel:
determine a location of the FWA device to be deployed; and when determining the quality of the at least one second radio channel further:
determine a location of the wireless communication device.

22. The device of claim 21, wherein the wireless communication device is considered to be located in a vicinity of the FWA device to be deployed if the distance between the two devices does not exceed a set maximum distance (d).

23. The device of claim 15, further being operative to:
detect type of FWA device to be deployed, the detected FWA device type being taking into account when determining the redeployment action to be performed, wherein
the detecting type of FWA device to be deployed comprises detecting whether the FWA device is stationary or semi-stationary.

24. (canceled)

25. The device of claim 14, the device being a radio base station serving the FWA device and the wireless communication device, or a radio base station serving the FWA device while receiving an indication of the quality of the at least a second radio channel from a neighbouring radio base station serving the wireless communication device, or a central device communicating with a first radio base station serving the wireless communication device and a second radio base station serving the FWA device.
